(19) United States
(12) Patent Application Publication
(10) Pub. No.: US 2003/0216984 A1
(43) Pub. Date: Nov. 20, 2003

(54) System and method for querying accounts receivable and supporting decision-making

(76) Inventor: Jiandong Wang, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/277,648

(22) Filed: Oct. 21, 2002

(30) Foreign Application Priority Data
May 17, 2002 (TW) 91110315

(51) Int. Cl. G06F 17/60

(52) U.S. Cl. 705/35

(57) ABSTRACT

A system and method for querying accounts receivable and supporting decision-making via an on-line analysis processing system. The system includes a financial accounting database (10), a database server (30), and a web server (20). The financial accounting database is for storing and managing data on financial matters of a company. The database server includes an accounts receivable database (301) and an accounts receivable cube database (302). The accounts receivable database is for storing and managing data received from the financial accounting database. The accounts receivable cube database is for generating data in multi-dimension structure according to the original data in the accounts receivable database, and for storing the data in multi-dimension structure. The web server, linked to the database server, provides a query interface. The web server comprises an identification module (210), an authorization module (211), a query and analysis module (212), a remarks module (213), a balancing module (214), and a bank account module (215).

### BACKGROUND OF THE INVENTION

1. Field of the Invention

The present invention relates to systems and methods for querying accounts receivable and supporting decision-making, and more particularly to a system and method for on-line querying and analyzing of accounts receivable using an on-line analysis processing system.

2. Description of Prior Art

Management personnel of any organization have to make informed decisions every day. To be able to make decisions wisely and quickly, managers need to have adequate information and be aware of all current internal and external conditions.

There are already well-developed technologies of querying, analyzing and processing information via the Internet. For example, U.S. Pat. No. 6,350,066 discloses a system and method for storing, delivering and managing messages. FIG. 7 is a schematic illustration of infrastructure and connections relating to a message storage and delivery system (MSDS) 6 as disclosed by this patent. A central office 4 of a telephone company is connected to a number of third parties, such as a telephone set 1, a facsimile machine 2, and a computer 3. After receiving a message, a direct inward dialing trunk 5 of the central office 4 forwards the message to the MSDS 6. The MSDS 6 checks and identifies the address of the message, translates the message into Hyper-text Markup Language (HTML), and stores the translated message in a database of the MSDS 6. The MSDS 6 is connected to the Internet 7. A user 8 queries the message at a computer terminal via the Internet 7. Even though this system can store and deliver messages, it has three obvious shortcomings. The first is that a company using the system cannot directly connect with the MSDS 6 when sending a new message or updating an old message. Therefore such company has to depend on the telephone company to transfer the message. The second is that the amount of transferred information is limited by the direct inward dialing trunks. The third is that the indirect delivery of information is rather costly.

Accordingly, what is needed is a system and method that quickly, conveniently and economically stores, delivers and processes information to support decision-making.

### SUMMARY OF THE INVENTION

A primary object of the present invention is to provide a system and method for querying accounts receivable and supporting decision-making, whereby management can quickly and conveniently query and analyze global accounts receivable to support decision-making relating thereto.

To achieve the above object, the present invention provides a system and method for querying accounts receivable and supporting decision-making. A preferred embodiment of the system comprises a financial accounting database, a database server, and a web server. The financial accounting database is for storing and managing data on financial matters of a company. The database server comprises an accounts receivable database and an accounts receivable cube database. The accounts receivable database is for storing and managing data received from the financial accounting database. The accounts receivable cube database is for generating data in multi-dimension structure according to the original data in the accounts receivable database, and for storing the data in multi-dimension structure. The web server is linked to the database server, and provides a query interface. The web server comprises: an identification module for identifying a user's ID; an authorization module for authorizing users to access the accounts receivable cube database; a query and analysis module for querying and displaying accounts receivable according to selected criteria; a remarks module for adding necessary description or comment to any account receivable; a balancing module for querying records of balancing of bank accounts; and a bank account module for querying changes of bank accounts.

A preferred embodiment of the method for querying accounts receivable and supporting decision-making comprises the steps of: periodically sending data on accounts receivable from a financial accounting database to an accounts receivable database via a data transferring service system; receiving the data from the financial accounting database and updating the accounts receivable database; generating an accounts receivable cube database according to the accounts receivable database; and visiting the accounts receivable cube database and querying accounts receivable via a web server.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is a schematic illustration of hardware and software infrastructure of a system for querying accounts receivable and supporting decision-making in accordance with a preferred embodiment of the present invention;

FIG. 2 is a schematic illustration of modules of a web server of the system of FIG. 1;

FIG. 3 is a flow chart of data on accounts receivable from a financial accounting database to an accounts receivable database based on the system of FIG. 1;

FIG. 4 illustrates a user interface for selecting criteria and content of a query, in accordance with the present invention;

FIG. 5 is a flow chart of querying procedures based on the system of FIG. 1;

FIG. 6 is a flow chart of sending of e-mail by a database server of the system of FIG. 1; and

FIG. 7 is a schematic illustration of conventional infrastructure and connections relating to a message storage and delivery system.

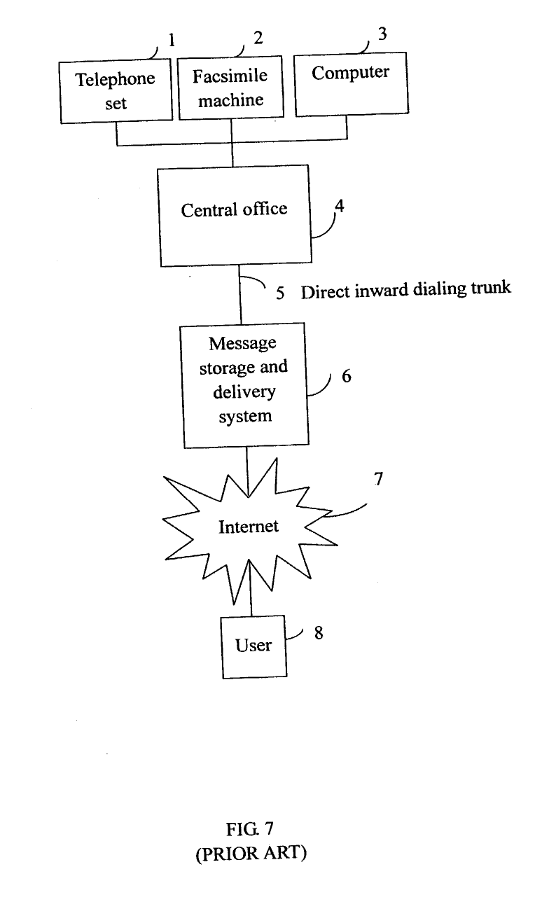

### DETAILED DESCRIPTION OF THE INVENTION

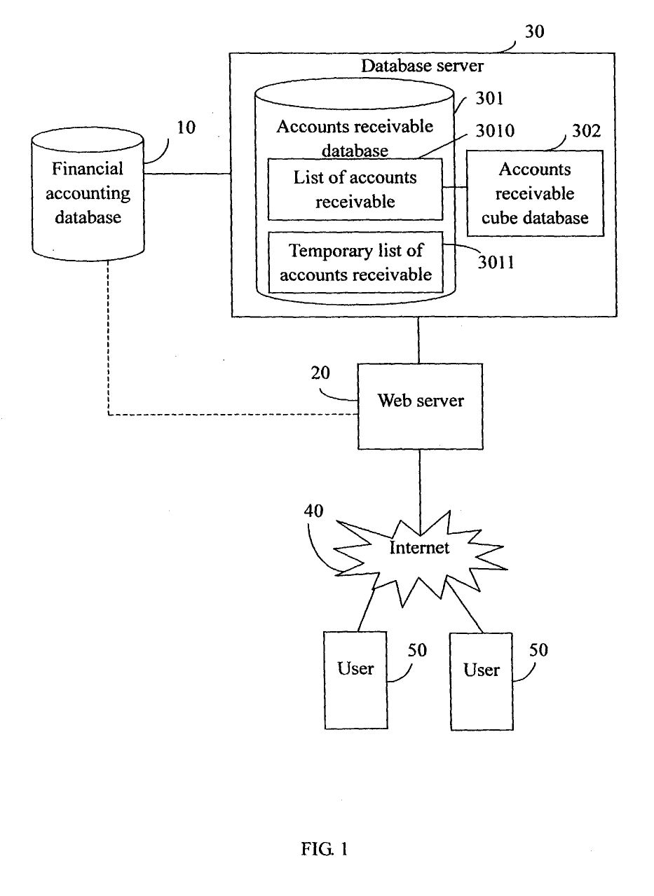

FIG. 1 is a schematic illustration of hardware and software infrastructure of a system for querying accounts receivable and supporting decision-making in accordance with a preferred embodiment of the present invention. The system comprises a financial accounting database 10, a web server 20, and a database server 30. The financial accounting database 10 is for storing and managing data on financial matters of an organization such as a company. The database server 30 comprises an accounts receivable database 301 and an accounts receivable cube database 302. The financial accounting database 10 automatically replicates data on accounts receivable to the accounts receivable database 301. The accounts receivable database 301 is for storing and managing data received from the financial accounting database 10. The accounts receivable database 301 includes a list of accounts receivable 3010, and a temporary list of accounts receivable 3011. The list of accounts receivable 3010 is for storing data received from the financial accounting database 10. The temporary list of accounts receivable 3011 is for updating the data in the list of accounts receivable 3010. The accounts receivable cube database 302 is for generating data in multi-dimension structure according to the original data in the accounts receivable database 301, and for storing the data in multi-dimension structure. The database server 30 also has an alert function. A user sets prerequisites and procedures for sending e-mail or other notices or alerts in advance. When the prerequisites are met, the database server 30 sends e-mail or other notices or alerts to a relevant manager and/or to a debtor regarding payment due from the debtor.

The web server 20 is linked to the database server 30, and provides a query interface. To query global accounts receivable, a user 50 electronically visits the web server 20 through a Security Socket Layer via the Internet 40. The user 50 then has access to the accounts receivable cube database 302. In addition, the web server 20 may also be linked to the financial accounting database 10.

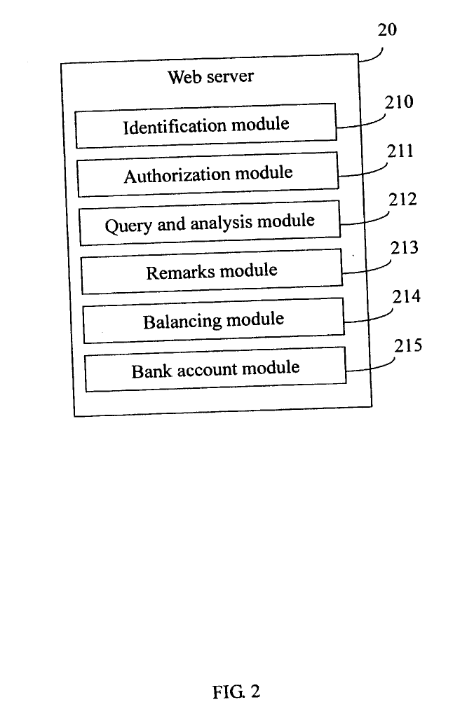

FIG. 2 is a schematic illustration of modules of the web server 20. The web server 20 comprises: an identification module 210 for identifying a user's ID; an authorization module 211 for authorizing users to access the accounts receivable cube database 302, the levels of access authorization including “administrator,” “financial accountant” and “ordinary user;” a query and analysis module 212 for querying and displaying accounts receivable according to selected criteria, the querying criteria including “business group\business unit\client,” “sales district\sales organization\client” and “client\business group\business unit,” and the display criteria including “alphanumerically” and “by chart;” a remarks module 213 for adding necessary description or comment to any account receivable; a balancing module 214 for querying records of balancing of bank accounts; and a bank account module 215 for querying changes of bank accounts by users.

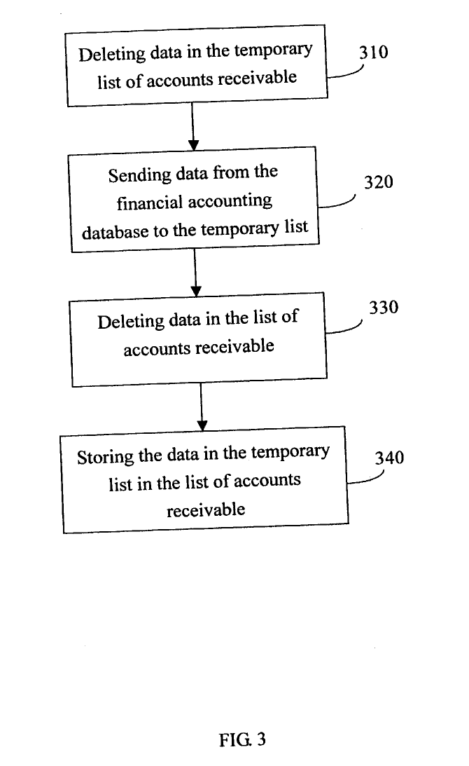

FIG. 3 is a flow chart of data on accounts receivable from the financial accounting database 10 to the accounts receivable database 301 based on the system disclosed herein. The financial accounting database 10 periodically sends data on accounts receivable via a data transferring service system (not shown in FIG. 3), to add to or update data in the accounts receivable database 301. For security reasons, the data on accounts receivable is not delivered directly from the financial accounting database 10 to the list of accounts receivable 3010. Instead, the data on accounts receivable is delivered via the temporary list of accounts receivable 3011. In addition, the accounts receivable database 301 is separate from enterprise resource planning of the company. The steps shown in FIG. 3 are described in detail as follows. In step 310, the data in the temporary list of accounts receivable 3011 is deleted. In step 320, the data transferring service system sends the data in the financial accounting database 10 to the temporary list of accounts receivable 3011. In step 330, data in the list of accounts receivable 3010 is deleted. In step 340, the data in the temporary list of accounts receivable 3011 is sent to the list of accounts receivable 3010.

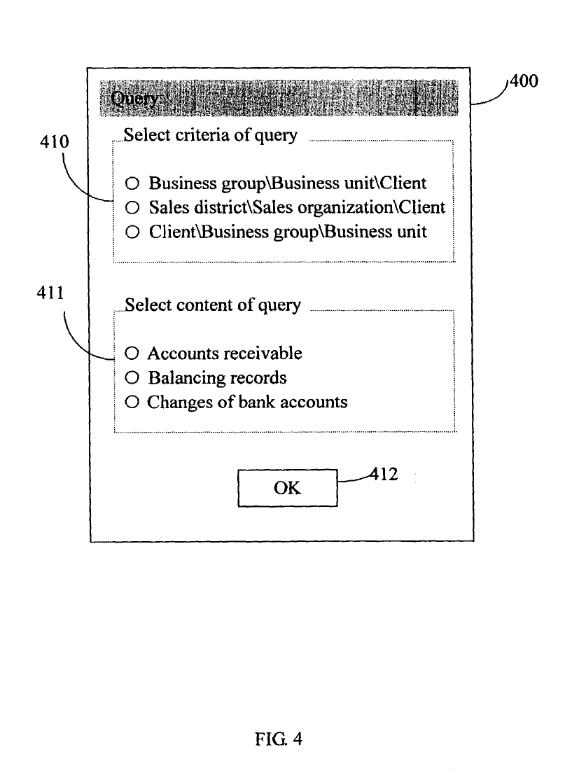

FIG. 4 illustrates a user interface 400 for selecting criteria and content of a query. The user interface 400 comprises two functional areas: a “Select criteria of query” area 410, and a “Select content of query” area 411. The Select criteria of query 410 include “Business group\Business unit\Client,” “Sales district\Sales organization\Client” and “Client\Business group\Business unit” radio buttons. The Select content of query 411 includes “Accounts receivable,” “Balancing records” and “Changes of bank accounts” radio buttons. A user selects desired radio buttons, and then presses the OK button 412. The user thus obtains the desired data for analysis.

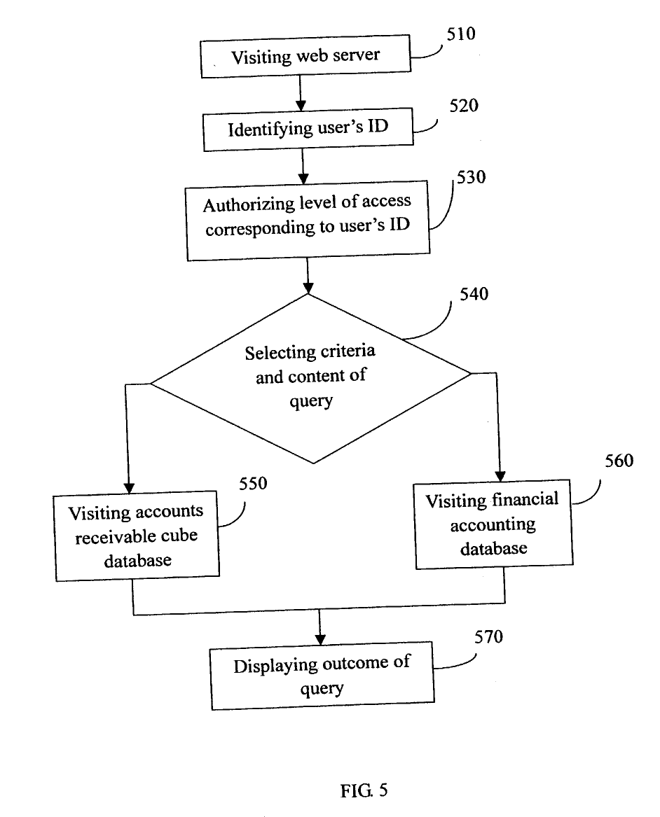

FIG. 5 is a flow chart of querying procedures based on the system disclosed herein. In step 510, the user 50 employs a browser to visit the web server 20 via the Internet 40. In step 520, the identification module 210 in the web server 20 identifies the user's ID when the user logs on the web server 20. In step 530, the authorization module 211 authorizes the user a predetermined level of access corresponding to the user's ID. In step 540, the user 50 selects a criterion and a content of query. In step 550, if the user 50 selects “Accounts receivable,” the query and analysis module 212 visits the accounts receivable cube database 302 in the database server 30 and obtains data in accordance with the user's requirements. On the other hand, in step 560, if the user 50 selects “Balancing records” or “Changes of bank accounts,” the balancing module 214 or the bank account module 215 visits the financial accounting database 10 and obtains the corresponding data. In step 570, the user 50 selects a means for displaying the requested information, and the outcome of the query is displayed by the web server 20 according to the selected means.

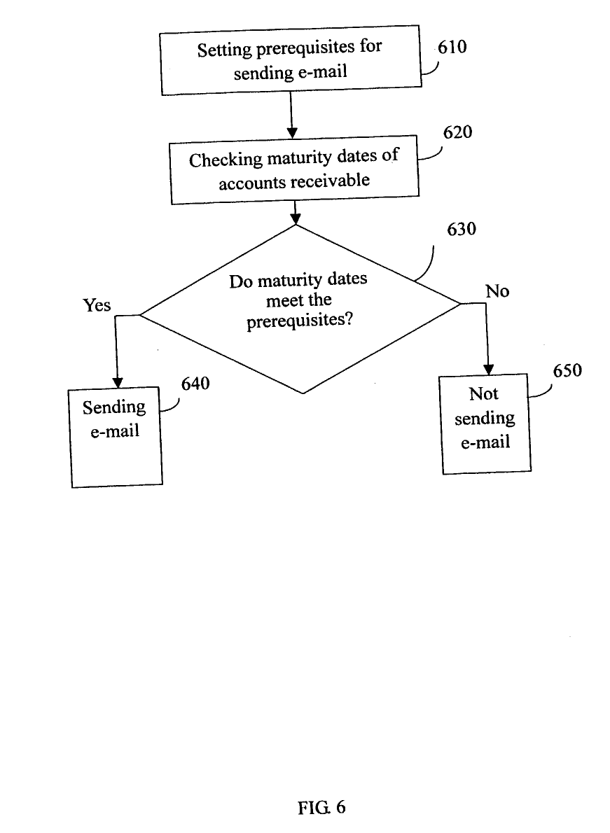

FIG. 6 is a flow chart of sending of e-mail by the database server 30. In step 610, relevant personnel set prerequisites and procedures for sending e-mail. In step 620, the database server 30 periodically checks maturity dates of all accounts receivable. In step 630, the database server 30 determines whether the maturity dates meet the prerequisites. In step 640, if the maturity date of an account receivable meets the prerequisites, the database server 30 sends e-mails to the relevant manager and/or to the debtor. In step 650, if the maturity date of an account receivable does not meet the prerequisites, the database server 30 does not send any e-mail.

The above-described preferred embodiment of the present invention is to be construed as being illustrative of the present invention and not restrictive. Modification of the preferred embodiment within the spirit of the invention will be apparent to those skilled in the art, and any such modification is included in the scope of the invention as defined by the following claims.

What is claimed is:

1. A system for querying accounts receivable and supporting decision-making, the system comprising:
a financial accounting database for storing and managing financial data;
a database server linked to the financial accounting database, the database server comprising an accounts receivable database for storing and managing data on accounts receivable received from the financial accounting database, and an accounts receivable cube database for generating data in multi-dimension structure and storing the data in multi-dimension structure; and
a web server linked to the database server for users to access the data on accounts receivable.

2. The system of claim 1, wherein the accounts receivable database comprises a list of accounts receivable for storing the data received from the financial accounting database, and a temporary list of accounts receivable for updating data in the list of accounts receivable.

3. The system of claim 1, wherein the web server is linked to the financial accounting database.

4. The system of claim 1, wherein the web server comprises:
an identification module for identifying a user's ID when the user logs on the web server;
an authorization module for authorizing users various access authorities;
a query and analysis module for querying accounts receivable;
a remarks module for adding necessary descriptions to accounts receivable;
a balancing module for querying records of balancing of bank accounts; and
a bank account module for querying changes of bank accounts.

5. The system of claim 4, wherein the access authorities comprise “administrator,” “financial accountant” and “ordinary user.”

6. A method for querying accounts receivable and supporting decision-making, the method comprising the steps of:
periodically sending data on accounts receivable from a financial accounting database to an accounts receivable database via a data transferring service system;
receiving the data on accounts receivable from the financial accounting database and updating the accounts receivable database;
generating data in multi-dimension structure according to the accounts receivable database, and storing the data in multi-dimension structure in an accounts receivable cube database; and
visiting the accounts receivable cube database and querying the data in multi-dimension structure via a web server.

7. The method of claim 6, wherein the accounts receivable database is separate from enterprise resource planning of an organization for security reasons.

8. The method of claim 6, wherein the sending of data on accounts receivable from the financial accounting database to the accounts receivable database comprises the following steps:
deleting data in a temporary list of accounts receivable in the accounts receivable database;
sending the data on accounts receivable in the financial accounting database to the temporary list of accounts receivable;
deleting data in a list of accounts receivable in the accounts receivable database; and
transmitting the data on accounts receivable in the temporary list of accounts receivable to the list of accounts receivable.

9. The method of claim 6, wherein the querying of data in multi-dimension structure via a web server comprises the following steps:
visiting the web server via the Internet by a user employing a browser;
identifying an ID of the user via an identification module;
authorizing the user access authority corresponding to the user's ID via an authorization module;
selecting a criterion and content of query;
visiting the accounts receivable cube database and obtaining data according to the user's query;
selecting a means to display an outcome of the query; and
displaying the outcome according to the selected means.

10. A method for sending e-mail regarding maturity of accounts receivable, the method comprising the steps of:
setting prerequisites and procedures for sending e-mail;
regularly checking maturity dates of accounts receivable;
determining whether the maturity dates meet the prerequisites; and
sending e-mail to a relevant manager and/or a debtor if the maturity date of an account receivable meets the prerequisites.
